(19) United States
(12) Patent Application Publication
(10) Pub. No.: US 2005/0158516 A1
(43) Pub. Date: Jul. 21, 2005

(54) Compressed wood product and electronic device exterior material

(75) Inventor: Tatsuya Suzuki, Tokyo (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/069,697

(22) Filed: Feb. 28, 2005

Related U.S. Application Data
(63) Continuation of application No. PCT/JP05/01158, filed on Jan. 21, 2005.

(30) Foreign Application Priority Data
Jan. 21, 2004 (JP) 2004-013240

(51) Int. Cl. B32B 3/00

(52) U.S. Cl. 428/156; 428/174

(57) ABSTRACT

A compressed wood product includes a wood whose shape is taken while a volume decreased by compression is previously added, wherein a direction along a fiber direction of the wood is set to a compression direction, and the wood is formed by being subjected to compressive force.

### CROSS-REFERENCE TO RELATED APPLICATIONS

The present application is a continuation of PCT/JP2005/001158 filed on Jan. 21, 2005, which claims priority to Japanese Patent Application No. 2004-013240, filed on Jan. 21, 2004.

### BACKGROUND OF THE INVENTION

1) Field of the Invention

The present invention relates to a compressed wood product including a compressed wood and an electronic device exterior material including the compressed wood product.

2) Description of the Related Art

Examples of a portable electric device that can be operated on hand include a camera, a mobile communication device (mainly cellular phone), an IC recorder, a PDA, a portable television, a portable radio, and remote controls for various home appliances. Usually, synthetic resins (ABS, polycarbonate, acrylic, and the like) and light metals (aluminum, stainless steel, titanium, magnesium, and the like) are used as the portable electronic device exterior material due to industrial mass production. Such the synthetic resins and light metals constituting the exterior material are oriented to industrial products while appropriate strength is obtained, so that there is no individual difference in appearance. Further, in the synthetic resins and the light metals constituting the exterior material, a flaw and discoloration are generated in long-term use. However, the flaw and the discoloration only impair the worth of the electronic device.

Therefore, it is thought that one may use wood which is of a natural raw material as the exterior material. Because the wood has various kinds of grain, the wood has the individual difference and individuality. Although the flaw and a change in color shade are generated in the long-term use in the wood, they become the unique feel and texture of the wood to cause users to feel an affinity.

A conventional method is well known in which the wood softened by absorbing moisture is compressed and held to fix a shape, then is sliced in a compression direction to obtain a plate-shaped primary fixed product, the primary fixed product is formed in a formed product having a predetermined three-dimensional shape while heated and absorbed, and the shape of the formed product is fixed to obtain a secondary fixed product (for example, see Japanese Patent No. 3078452).

A conventional method is well known, in which a woody material compressed in a state in which the softening treatment is performed is temporarily fixed and then is recovered in a form to perform forming, as a method of three-dimensionally processing the woody material (for example, see Japanese Patent Application Laid-Open No. 11-77619).

### SUMMARY OF THE INVENTION

It is an object of the present invention to at least solve the problems in the conventional technology.

A compressed wood product according to one aspect of the present invention includes a wood whose shape is taken while a volume decreased by compression is previously added, wherein a direction along a fiber direction of the wood is set to a compression direction, and the wood is formed by being subjected to compressive force.

### BRIEF DESCRIPTION OF THE DRAWINGS

FIG. 1 is a sectional view that depicts an electronic device in which a compressed wood product according to a first embodiment is used as an exterior material;

FIG. 2 is a perspective view that depicts shape taking of a compressed wood product according to the first embodiment;

FIG. 3 is a plan view that depicts shape taking of a compressed wood product according to the first embodiment;

FIGS. 4A to 4C are views that depict a process of compressing wood;

FIGS. 5A and 5B are sectional views that depict wood with a reinforcement structure; and

FIG. 6 is a perspective view that depicts wood with another reinforcement structure.

### DETAILED DESCRIPTION

Exemplary embodiments of a compressed wood product relating to the present invention will be explained in detail below with reference to the accompanying drawings.

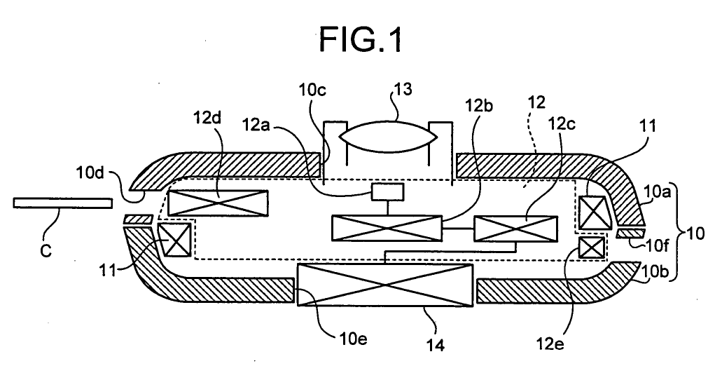

FIG. 1 is a sectional view that depicts an electronic device in which a compressed wood product according to the first embodiment is used as an exterior material. In FIG. 1, a digital camera is shown as an example of the electronic device. The digital camera has a reinforcing frame 11 and an inner mechanism 12 inside an exterior material 10 formed by the compressed wood product. The digital camera also has an image taking lens 13 and a liquid crystal monitor 14 while the image taking lens 13 and the liquid crystal monitor 14 are exposed to the outside of the exterior material 10. The inner mechanism 12 includes an image pickup device 12a such as a CCD, a drive circuit 12b that drives the image pickup device 12a, a drive circuit 12c that drives the liquid crystal monitor 14, a recording device 12d for an image recording medium C, and a connection terminal 12e connected to an external personal computer.

The exterior material 10 includes a front cover 10a and a rear cover 10b. A lens hole 10c is made in a main plate portion of the front cover 10a so that the image taking lens 13 is projected outside of the front cover 10a. The lens hole 10c is made corresponding to an outer shape of a holding portion that holds the image taking lens 13. For example, when the holding portion has a cylindrical shape, the lens hole 10c is made in a circular shape so that the holding portion is projected outside of the front cover 10a. An aperture 10d is provided in a side plate portion of the front cover 10a so that the image-recording medium C is inserted into or extracted from the aperture 10d. A rectangular window 10e is made in the main plate portion of the rear cover 10b so that the liquid crystal monitor 14 is exposed outside of the rear cover 10b. An aperture 10f is provided in the side plate portion of the rear cover 10b so that a connection cable connected to the connection terminal 12e is inserted into or extracted from the aperture 10f. In addition, although not shown in the drawings, button holes are made in the front cover 10a and the rear cover 10b so that various operation buttons for operating the digital camera are exposed. A cover and the like may be provided in the button hole if needed.

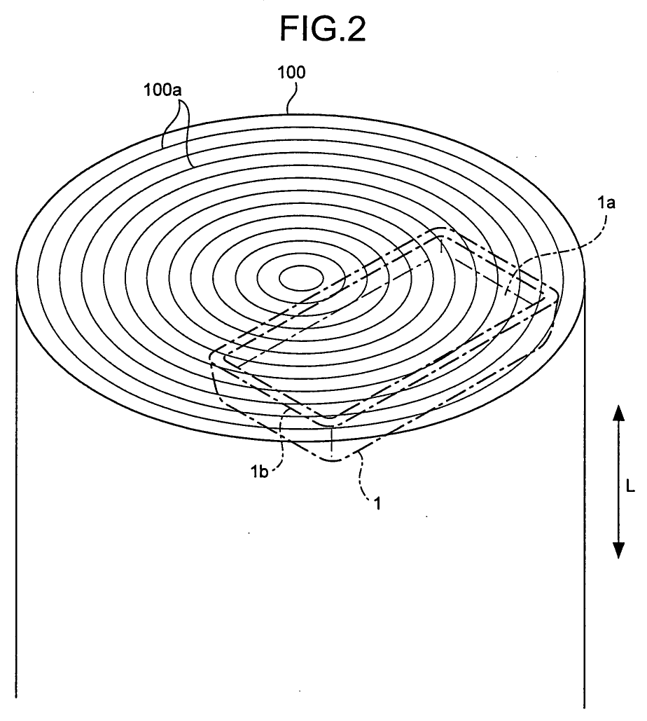

FIG. 2 is a perspective view that depicts shape taking of the compressed wood product according to the first embodiment, and FIG. 3 is a plan view that depicts shape taking of the compressed wood product according to the first embodiment. As shown in FIG. 2, the compressed wood product constituting the exterior material 10 is made by compressing a wood 1. The shape of the wood 1 is taken from a raw material 100 before the wood 1 is compressed. Examples of the raw material 100 include Japanese cypress (hinoki, hiba), paulownia (kiri), teak, mahogany, Japanese cedar, pine, and cherry. The wood 1 is a lump including a main plate portion 1a having a predetermined shape (substantially rectangular shape in the first embodiment) and a side plate portion 1b provided while vertically rising from a periphery of the main plate portion 1a. The main plate portion 1a forms the main plate portion of the front cover 10a or the rear cover 10b, and the side plate portion 1b forms the side plate portion of the front cover 10a or the rear cover 10b. In the wood 1, the main plate portion 1a and the side plate portion 1b are formed so as to be coupled to each other in a smooth curved surface.

As shown in FIG. 3, with reference to a mode in which the shape of the wood 1 is taken from the raw material 100, the shape of the wood 1 is taken while a thickness direction of the main plate portion 1a exists along the fiber direction and the surface that reveals itself in the thickness direction has the end grain surface.

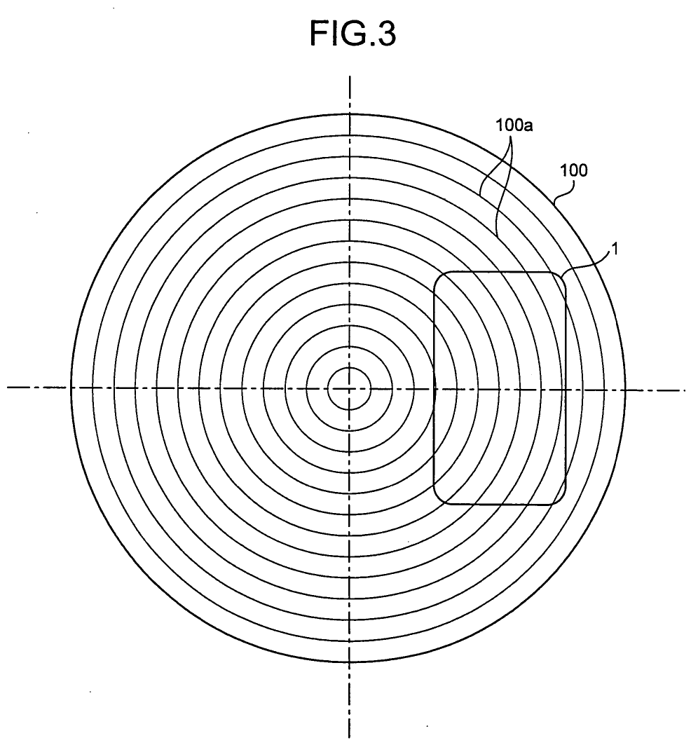

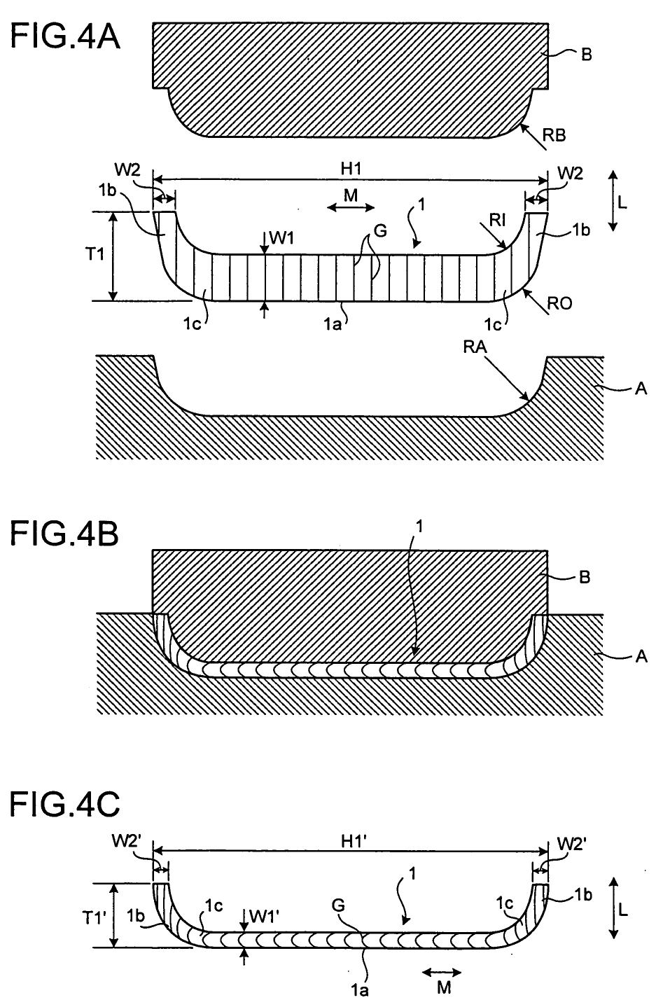

FIG. 4 is a view that depicts a process of compressing the wood. The shape of the wood 1 is taken while a volume decreased by the compression is previously added. Specifically, as shown in FIG. 4A, the shape of the main plate portion 1a is taken with a thickness W1 in which the volume decreased by the compression is previously added. The shape of the side plate portion 1b is taken with a thickness W2 and a height T1 in which the volume decreased by the compression is previously added. The shape of the wood 1 is taken with a total width H1. The thickness W1 of the main plate portion 1a is formed larger than the thickness W2 of the side plate portion 1b. A middle portion between the main plate portion 1a and the side plate portion 1b is formed in the smooth curve so that the thickness W1 of the main plate portion 1a is gradually changed to the thickness W2 of the side plate portion 1b. The side plate portion 1b is formed so as to rise obliquely outward from the main plate portion 1a. In the wood 1, FIG. 4 shows the shape of either the front cover 10a or the rear cover 10b in the exterior material 10 formed of the compressed wood product. The drawing and the description of the shape of the other are not repeated, because the shapes of the front cover 10a and the rear cover 10b are similar to each other.

The wood 1 is compressed between a lower form frame A and an upper form frame B. As shown in FIG. 4A, the lower form frame A has a concave surface that hits against a curved outside surface (lower surface in FIG. 4). In the curved outside surface, the side plate portion 1b rises from the main plate portion 1a of the wood 1. The concave surface of the lower form frame A has the shape to which the outside surface of the wood 1 is fitted. The radius of curvature of a curved surface RO at the outside surface of the wood 1 and the radius of curvature of a curved surface RA at the lower form frame A that is opposite to the curved surface RO have a correlation of RO>RA. On the other hand, the upper form frame B has a convex surface that hits against a curved inside surface (upper surface in FIG. 4). In the curved inside surface, the side plate portion 1b rises from the main plate portion 1a of the wood 1. The convex surface of the upper form frame B has the shape to which the inside surface of the wood 1 is fitted. The radius of curvature of a curved surface RI at the inside surface of the wood 1 and the radius of curvature of a curved surface RB at the upper form frame B that is opposite to the curved surface RI have the correlation of RI>RB. After the lower form frame A and the upper form frame B are combined, i.e. after the wood 1 is compressed, a space formed between the concave surface of the lower form frame A and the convex surface of the upper form frame B has the shape of post-compression of the wood 1. (see FIG. 4B).

With reference to the wood 1 and the lower and upper form frames A and B having the above-described configurations, first the wood 1 is placed in a water vapor atmosphere at high temperature and high pressure as shown in FIG. 4A. When the wood 1 is placed in the water vapor atmosphere at high temperature and high pressure for a predetermined time, the wood 1 is softened by excessively absorbing moisture. In the water vapor atmosphere at high temperature and high pressure, the wood 1 is arranged between the lower form frame A and the upper form frame B and on the concave surface of the lower form frame A. At this point, since the main plate portion 1a has the end grain surface, the wood 1 has the mode in which a direction M in which the pieces of grain G are laminated exists in a horizontal direction of FIG. 4 and a fiber direction L exists along a vertical direction of FIG. 4.

Then, as shown in FIG. 4B, the wood 1 is compressed by bringing the upper form frame B close to the lower form frame A. Namely, the convex surface of the upper form frame B is fitted into the concave surface of the lower form frame A. In the wood 1 sandwiched between the lower form frame A and the upper form frame B, compressive force is applied to the main plate portion 1a in the thickness W1 direction (direction along the grain G), and the compressive force is also applied to the main plate portion 1a in the direction along the fiber direction L. In the wood 1, the compressive force is applied to the side plate portion 1b in the thickness W2 direction (direction M in which the pieces of grain G are laminated) and in the height T1 direction (direction along the grain G), and the compressive force is also applied to the side plate portion 1b in the direction along the fiber direction L. Further, in the wood 1, the compressive force is applied to a curved portion 1c that couples the main plate portion 1a and the side plate portion 1b in the direction M in which the pieces of grain G are laminated and in the direction along the grain G, and the compressive force is also applied to the curved portion 1c in the direction along the fiber direction L. Specifically, the curved portion 1c is formed so that the side plate portion 1b rises obliquely outward, and the radii of curvature of the lower and upper form frames A and B has the relationship described above. Therefore, the compressive force is applied upward to the outside surface of the curved portion 1c, and the compressive force is applied downward to the inside surface. Then, the wood 1 is left for a predetermined time while the compressive force is applied to the wood 1.

Finally, after the wood 1 is left for the predetermined time, the water vapor atmosphere at high temperature and high pressure is released, the upper form frame B is separated from the lower form frame A, and the compressed wood 1 is taken out as shown in FIG. 4C. In the compressed wood 1 taken out from between the lower and upper form frames A and B, the wood 1 is compressed to substantially even thicknesses W1′and W2′ at the main plate portion 1a and the side plate portion 1b, respectively. In the compressed wood 1, the side plate portion 1b is compressed to a height T1′. In the compressed wood 1, the curved portion 1c that couples the main plate portion 1a and the side plate portion 1b is compressed so that the pieces of grain G are laminated. The compressed wood 1 is slightly compressed to a width H1′.

Thus, in the compressed wood 1, since the compressive force is applied in the direction along the fiber direction L, the cut surface of the fiber reveals itself in the compressed surface. As a result, the perspiration-absorption characteristics can be improved. Particularly, since the main plate portion 1a has the end grain surface, the cut surface of the fiber reveals itself. Therefore, the higher perspiration-absorption characteristics are obtained to improve portability. Further, since the main plate portion 1a has the end grain surface, the shapes of the wood 1 having the similar end grain surface can be taken. Therefore, the compressed woods with the equivalent strength and pattern can be obtained.

In the side plate portion 1b, since the compressive force is applied in the direction M in which the pieces of grain G are laminated, the pieces of hard fiber of the grain G are bundled to increase fiber density, which imparts the high strength to the side plate portion 1b. Further, in the curved portion 1c that couples the main plate portion 1a and the side plate portion 1b, since the compressive force is applied in the direction M in which the pieces of grain G are laminated, the fiber density is increased to impart the high strength to the curved portion 1c.

Thus, the compressed wood product has the sufficient perspiration-absorption characteristics for the electronic device exterior material by using the compressed wood product as the electronic device exterior material.

As described above, when the surface in the thickness direction of the main plate portion 1a has the end grain surface, it is expected that the strength is decreased against pressing force toward the direction of the surface. Therefore, it is preferable to reinforce the surface in the thickness direction of the main plate portion 1a as follows.

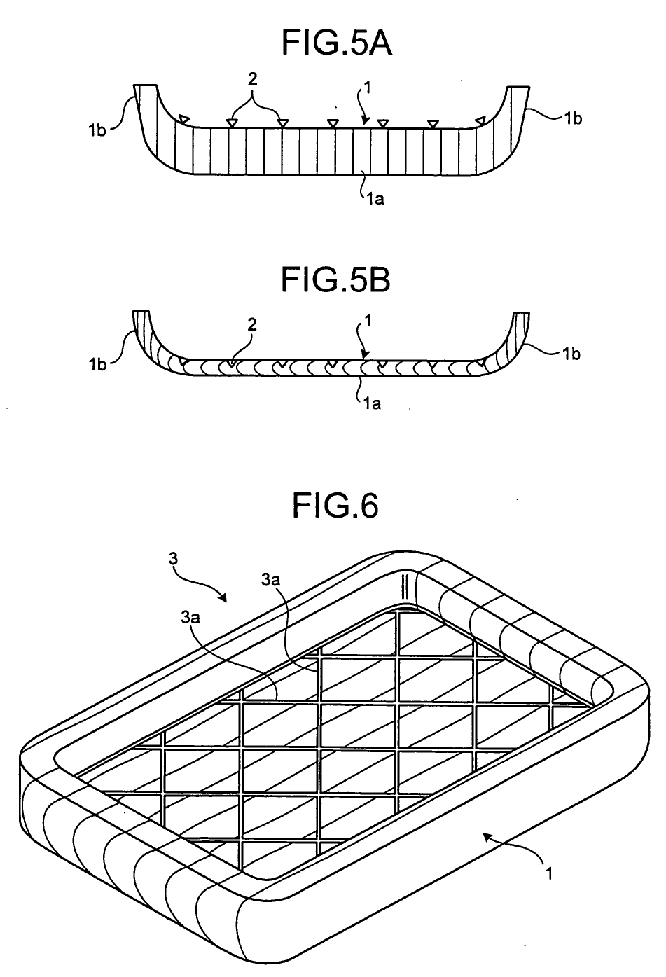

FIG. 5 is a sectional view that depicts the wood with a reinforcement structure. In the reinforcement structure shown in FIG. 5, a plurality of rod-shaped materials 2 are arranged in parallel as the reinforcement material with respect to the inside surface of the main plate portion 1a. The rod-shaped material 2 is formed of a metal material or a synthetic resin that is harder than the wood 1. In this case, as shown in FIG. 5A, the rod-shaped materials 2 are arranged in parallel on the inside surface of the wood 1 at predetermined intervals before the compression. Then, as shown in FIG. 5B, the rod-shaped materials 2 are embedded into the inside surface of the wood 1 to be integrated with the wood 1 by the compression. This allows the strength of the main plate portion 1a to be improved in the wood 1. The strength of the main plate portion 1a is further improved in the wood 1 by providing the rod-shaped material 2 while orientated toward the direction intersecting the grain G. When the rod-shaped material 2 made of metal is quenched, the strength of the main plate portion 1a can be improved by metal hardening.

FIG. 6 is a perspective view that depicts the wood with another reinforcement structure. In the reinforcement structure shown in FIG. 6, a network material 3 is arranged as the reinforcement material with respect to the inside surface of the main plate portion 1a. The network material 3 is formed of a metal material or a synthetic resin that is harder than the wood 1. In this case, similarly to the mode shown in FIG. 5, the network material 3 is embedded into the inside surface of the wood 1 to be integrated with the wood 1 by the compression. Because the network material 3 is formed by intersecting a plurality of linear materials 3a one another, the wood with the reinforcement structure shown in FIG. 6 has the high strength in the surface direction. In addition to the network material 3, when a punching metal and the like are used as the reinforcement material, the strength of the main plate portion 1a can also be improved.

It is possible to burn the surface of the wood 1 (compressed wood product) obtained by the compression in the embodiment. Depressions and projections are generated in the grain G portion by burning the surface of the wood 1, which further improves the perspiration-absorption characteristics and the effect of the slip resistance. Further, a carbonized layer obtained by burning the surface of the wood 1 becomes a conductive material, and the carbonized layer becomes an electromagnetic shielding material which is far lighter than metal, so that the wood 1 obtained by the compression can be used effectively as the electronic device exterior material.

In the embodiment, the compressed wood product having the structure in which the side plate portion 1b rises from the main plate portion 1a is described as an example. However, the invention is not limited to the embodiment. As described above, the invention can be applied to any shape of goods, e.g. tableware, as long as the perspiration-absorption characteristics are obtained by applying the compressive force in the direction along the fiber direction L of the wood 1. For the electronic device exterior material, the invention is not limited to the digital camera, but the invention can be applied to the portable electronic device such as a camera, a mobile communication device (mainly cellular phone), an IC recorder, a PDA, a portable television, a portable radio, and remote controls for various home appliances.

It is known that the wood has the nature to generate perspiration-absorption characteristics, so as to conform to a human hand when a user touches the wood. In order to obtain the perspiration-absorption characteristics it is necessary that a cut surface of wood fiber reveals itself as the surface which the user should touch. In the above conventional art, because the wood compressed is first cut along a fiber direction, the surface that reveals itself becomes a flat-grain surface, a straight-grain surface, or an edge-grain surface, which reduces the perspiration-absorption characteristics. However, in the embodiments explained above, the compressed wood product and the electronic device exterior material are suitable for the improvement of the perspiration-absorption characteristics by previously considering the compression direction with respect to the wood to take the shape of the wood and performing the compression forming.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A compressed wood product comprising a wood whose shape is taken while a volume decreased by compression is previously added, wherein a direction along a fiber direction of the wood is set to a compression direction, and the wood is formed by being subjected to compressive force.

2. The compressed wood product according to claim 1, comprising a main plate portion in which a surface emerging in a thickness direction has an end grain surface and a side plate portion provided while rising from the main plate portion, the shape of the main plate portion being taken with a thickness to which the volume decreased by the compression is previously added, the shape of the side plate portion being taken with a thickness and a height to which the volume decreased by the compression is previously added.

3. The compressed wood product according to claim 2, comprising a curved portion provided between the main plate portion and the side plate portion, the shape of the curved portion being taken while the volume decreased by the compression is previously added wherein the curved portion is subjected to both the compressive force to which the main plate portion is subjected and the compressive force to which the side plate portion is subjected.

4. An electronic device exterior material formed by a compressed wood product according to claim 1.
